(19) United States
(12) Patent Application Publication
(10) Pub. No.: US 2020/0374448 A1
(43) Pub. Date: Nov. 26, 2020

(54) INSTANT REACTION PROTECTION SYSTEM INCLUDING A COMBINED CAMERA-IMMOBILIZER UNIT

(71) Applicant: Edmundo De La Torre, Laredo, TX (US)

(72) Inventor: Edmundo De La Torre, Laredo, TX (US)

(21) Appl. No.: 16/416,292

(22) Filed: May 20, 2019

(51) Int. Cl. H04N 5/232; G03B 17/56; G02B 27/20; H04N 5/225; F41H 13/00

(52) U.S. Cl. CPC H04N 5/23203; G03B 17/561; G02B 27/20; H04N 5/23296; H04N 5/23238; F41H 13/0025; H04N 5/23299; H04N 5/2253

(57) ABSTRACT

An instant reaction protection system including a combined camera-immobilizer, a laser sight, a control unit and a mounting member. The combined camera-immobilizer unit including a camera member and an immobilizer member, wherein the immobilizer member includes a housing and an electrical shock firing mechanism. The housing includes a cavity for receiving the combined camera-immobilizer unit. The camera member monitors a predetermined region to aid in detecting a threat and the immobilizer discharges at least one electric shock to immobilize the detected threat when a discharge trigger occurs. The laser sight aids the immobilizer in aiming at a detected treat and is integrated with the combined camera-immobilizer unit. The laser sight aims a beam at the detected threat. The control unit remotely controls the combined camera-immobilizer unit and the laser sight. The control unit includes a key switch and a key opening for securely activating the key switch thereby causing a discharge trigger to occur. The mounting member is attachably connected to the housing member and mounts the combined camera-immobilizer unit to a fixed structure at a position that allows the camera to patrol a predetermined region for threats and allows the immobilizer to accurately fire at a detected threat.

### FIELD OF THE INVENTION

Embodiments described herein generally relate to a safety systems, and more particularly to a combined immobilizer-camera safety system.

### BACKGROUND OF THE INVENTION

Gun violence is a big problem in the world today. As policy-making has proven to be a slow route in remedying the recurring state of gun violence, some have turned to innovation to prevent disaster when violent situations arise. While talks of technologically advanced firearms are underway, it is desirable to provide safety methods and systems that can be implemented swiftly and effectively in schools, homes, and offices in the event of gun violence.

### BRIEF DESCRIPTION OF THE DRAWINGS

The various advantages of the embodiments of the present disclosure will become apparent to one skilled in the art by reading the following specification and appended claims, and by referencing the following drawing(s), in which:

FIG. 1 shows an exemplary view of an instant reaction protection system including a combined camera-immobilizer unit according to an embodiment of the present disclosure.

### SUMMARY OF THE INVENTION

Exemplary embodiments disclosed herein describe an instant reaction protection system including a combined camera-immobilizer, a laser sight, a control unit and a mounting member. The combined camera-immobilizer unit including a camera member and an immobilizer member, wherein the immobilizer member includes a housing and an electrical shock firing mechanism. The housing includes a cavity for receiving the combined camera-immobilizer unit. The camera member monitors a predetermined region to aid in detecting a threat and the immobilizer discharges at least one electric shock to immobilize the detected threat when a discharge trigger occurs. The laser sight aids the immobilizer in aiming at a detected treat and is integrated with the combined camera-immobilizer unit. The laser sight aims a beam at the detected threat. The control unit remotely controls the combined camera-immobilizer unit and the laser sight. The control unit includes a key switch and a key opening for securely activating the key switch thereby causing a discharge trigger to occur. The mounting member is attachably connected to the housing member and mounts the combined camera-immobilizer unit to a fixed structure at a position that allows the camera to patrol a predetermined region for threats and allows the immobilizer to accurately fire at a detected threat.

In some exemplary embodiments, the camera member is a pan, tilt, zoom camera.

In some exemplary embodiments, the camera member is a three hundred and sixty (360) degrees horizontal and ninety (90) degrees vertical camera.

In some exemplary embodiments, the electrical shock firing mechanism is a taser mechanism.

In some exemplary embodiments, the electrical shock firing mechanism is a stun gun mechanism.

In some exemplary embodiments, the control unit includes a power button and a laser sight activator button.

### DETAILED DESCRIPTION

The present disclosure relates to an instant reaction protection system (“the system”). The system is integrated in a three hundred and sixty (360) degrees horizontal and ninety (90) degrees vertical PTZ camera combined with an immobilizer and a laser sight and is operated from a remote control panel to activate a security key. Essentially, when a threat is detected, such as, for example, an active shooter in a public place, the laser sight is activated to point at the threat. Once the threat enters the firing range, the immobilizer discharges one or more electric shocks at the threat to immobilize the threat.

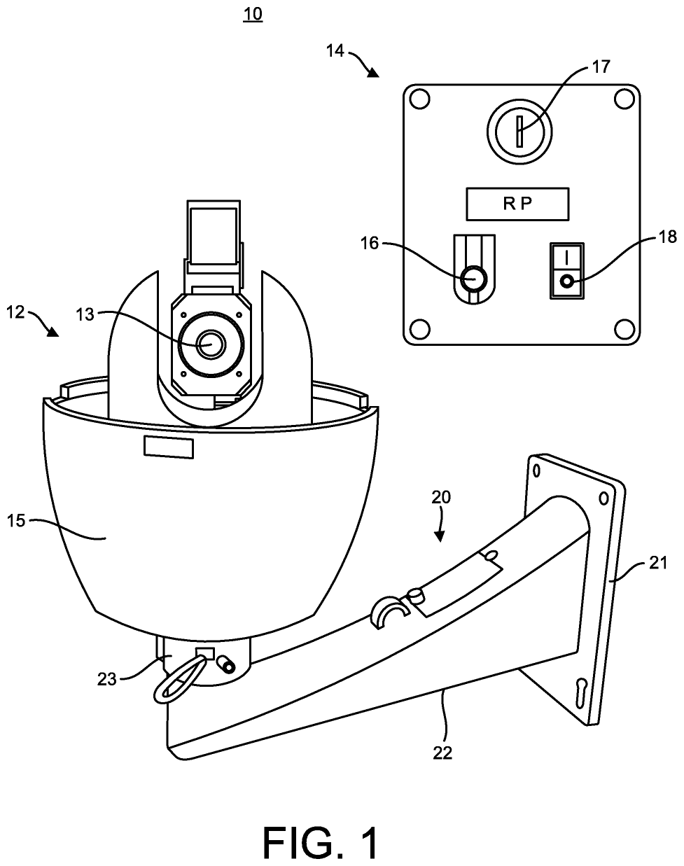

As illustrated in FIG. 1, the system includes a combined camera-immobilizer unit 12, a mounting member 14, and a control panel 16. The combined camera-immobilizer unit includes a camera member 13, and an immobilizer unit 15. The camera may be any suitable camera, such as, for example, an Internet Protocol (IP) camera, a webcam or a closed circuit television camera (CCTV). The camera member 13 may include night vision and/or thermal imaging.

In a preferred embodiment, the camera is an IP camera that feeds or streams its image in real time to or through a computer to a computer network. When received by the computer, the video stream may be saved, viewed or sent on to other networks travelling through the internet and e-mailed as an attachment.

Moreover, in a preferred embodiment, the camera 13 has pan, tilt and zoom (PTZ) functionalities. The PTZ camera allows a user to control the movement and position of the lens from a remote location using controls on an Internet browser or software application. Panning refers to horizontal movement of the lens where tilting describes vertical movement. The zooming process refers to the adjustment of the focal length of the lens to make a subject appear close-up or far away depending on the setting. The movement and position of the camera may be controlled, for example, using a joystick or a smart phone. The PTZ camera member has panning (i.e., horizontal) movement of three hundred and sixty (360) degrees and tilting (i.e., vertical) movement of ninety (90) degrees.

The camera member 13 monitors a predetermined region, such as, for example, a public place, to aid in detecting a threat. The camera member may be operated manually (i.e., user movement of the camera) to monitor the predetermined region and a threat may be detected by a visual sighting of the threat by the user-operator.

Alternatively, the camera member 13 may be programmed to monitor user-defined preset positions within the predetermined region to aid in detecting a threat. The user-defined preset positions allow the user to specify a number of positions that the user can easily monitor. The preset positions can also be used with alarm triggers, so for example, the camera member may include a motion detector and when the camera detects motion it can be directed to move to a specified preset position. Upon the detection of motion, a notification can be sent to the user to alert the user that motion has been detected so that the user may inspect the image being streamed from the camera member at the preset position to detect a threat.

Moreover, the camera member 13 may include patrolling and auto panning features which will allow the camera to move automatically between user-defined preset positions providing remote surveillance of a wide area with no user input. In conjunction with the motion detection, the camera member may use its pan-tilt functions to follow moving targets and the camera member may alert the user of the motion so that the user may perform an inspection to detect a threat.

The laser sight (not shown) is connected to the top structure of the camera member 13 and is used to aid in accurately landing electric shocks discharged from the immobilizer 15 at a detected threat. When the laser sight is activated, the laser sight projects a color beam at the detected threat which appears as a visible colored dot on the point of impact at the detected threat. The laser sight is controlled and activated by control unit 14.

The immobilizer member 15 immobilizes a detected threat by discharging at least one electric shock to the detected threat which disrupts the voluntary control of muscles, causing neuromuscular incapacitation. The immobilizer discharges the at least one shock when a discharge trigger occurs. The discharge trigger is controlled by control unit 14. The immobilizer member includes a housing unit and an electrical shock firing mechanism encased within the housing unit.

The electrical shock firing mechanism includes a chamber containing a pair of small barbed dart-like electrodes and propellant for discharging at least one electric shock. The electrical shock firing mechanism fires the two small barbed dart-like electrodes which are pointed to penetrate the clothing of the threat and are barbed to prevent removal once in place. The dart-like electrodes stay connected to a main unit by conductive wire as they are propelled by small compressed nitrogen charges. The main unit, by thin insulated copper wire, delivers electric current to the electrodes which causes a discharge of electric shock to the detected threat, thereby immobilizing the threat. In a preferred embodiment, the electrical shock firing mechanism is a taser mechanism. In an alternative embodiment, the electrical shock firing mechanism is a stun gun.

The housing unit includes a cavity for receiving the combined camera-immobilizer unit 12 and the housing unit includes one or more openings for the release of the two small barbed darts. The housing unit may be made from any suitable material, such as, for example, plastic.

The control unit 16 remotely controls the combined camera-immobilizer unit 12 and the laser sight. The control unit includes a laser sight activator button 16, a key switch (not shown), a key opening 17, and a power button 18. The laser sight activator button when depressed causes an activation signal to be sent to the laser sight which activates the laser sight. The key switch, when activated, causes the occurrence of a discharge trigger (i.e., a discharge trigger signal is sent to the combined camera-immobilizer unit) which causes the immobilizer to discharge at least one electric shock to a detected threat.

The key opening receives a security key to activate the key switch. When a threat is detected, the user may wait until the threat is in a firing range and then the user may activate the immobilizer by inserting the security key into the key opening and turning the key in the appropriate direction to generate a discharge trigger.

The mounting member 14 is attachably connected to the housing member of the immobilizer for mounting the combined camera-immobilizer unit to a fixed structure at a position that allows the camera member 13 to monitor a predetermined region to aid in the detection of threats and a position that allows the immobilizer to accurately discharge the at least one electric shock at a detected threat.

The mounting member includes at least one external structure panel 17, at least one arm 18 and at least one connector 19. The external structure panel may be attached to a fixed structure, such as, for example, the external structure of a building. The arm 18 and connector 19 connect the combined camera-immobilizer to the external structure panel. The mounting member may be attached to a fixed structure at a position, such as, for example, at a particular position along the external structure of the building, that allows the camera member to view the predetermined region. The mounting member may be made from any suitable material sufficient to support the weight of the camera-immobilizer.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.)

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

Those skilled in the art will appreciate from the foregoing description that the broad techniques of the embodiments of the present invention may be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

What is claimed is:

1. An instant reaction protection system comprising:
a combined camera-immobilizer unit including a camera member and an immobilizer member, the immobilizer member including a housing and an electrical shock firing mechanism, the housing including a cavity for receiving the combined camera-immobilizer unit, the camera member monitors a predetermined region to aid in detecting a threat and the immobilizer discharges at least one electric shock to immobilize the detected threat when a discharge trigger occurs;
a laser sight for aiding the immobilizer in aiming at a detected treat, the laser sight is integrated with the combined camera-immobilizer unit and projects a beam at the detected threat upon activation;
a control unit for remotely controlling the combined camera-immobilizer unit and the laser sight, the control unit including a key switch and a key opening for receiving a security key to securely activate the key switch thereby causing an occurrence of a discharge trigger; and
a mounting member attachably connected to the housing member for mounting the combined camera-immobilizer unit to a fixed structure at a position that allows the camera to monitor a predetermined region to aid in the detection of threats and that allows the immobilizer to discharge the at least one electric shock at a detected threat.

2. The system of claim 1, wherein the camera member is a pan tilt zoom camera.

3. The system of claim 2, wherein the camera member is a three hundred and sixty (360) degrees horizontal and ninety (90) degrees vertical camera.

4. The system of claim 1, wherein the electrical shock firing mechanism is a taser mechanism.

5. The system of claim 1 wherein the electrical shock firing mechanism is a stun gun mechanism.

6. The system of claim 1, wherein the control unit includes a power button and a laser sight activator button.
